(19) United States
(12) Patent Application Publication
(10) Pub. No.: US 2011/0034097 A1
(43) Pub. Date: Feb. 10, 2011

(54) Ventilative and Absorptive Textile with Porous Material and Preparation Thereof

(75) Inventors: Kuo-Chin Chen, Taipei Hsien (TW); Shuo-Ting Hung, Taipei Hsien (TW); Lai-Hung Wan, Taipei Hsien (TW); Yu-Ping Chuang, Taipei Hsien (TW); Yu-Chin Huang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: SINGTEX INDUSTRIAL CO., LTD., Taipei Hsien (TW)

(21) Appl. No.: 12/851,904

(22) Filed: Aug. 6, 2010

(30) Foreign Application Priority Data
Aug. 6, 2009 (TW) 098126582

(51) Int. Cl. B32B 5/18; B05D 3/00; B32B 3/26

(52) U.S. Cl. 442/76; 427/372.2; 428/304.4

(57) ABSTRACT

The present invention provides a method of preparing a textile with a porous material, comprising: (a) mixing a solution containing the porous material, a resin and a foam stabilizer to form a mixture; (b) foaming the mixture of (a) to form a foam; (c) coating the foam of (b) to the surface of the textile; and (d) drying the textile of (c).

The present invention also provides a textile contained porous material, comprising a porous material, a resin layer and a fabric, membrane or released substance.

### FIELD OF THE INVENTION

The present invention is related to a textile with a porous material and preparation thereof.

### BACKGROUND OF THE INVENTION

With improvement of technology and life quality, people pay more and more attention to article for daily use, especially in comfortable and healthy-function clothes. People try to wear textile with different functions, such as deodorization, breathable, cooling, warm-reservation, penetrative, water-repellence, and so on.

It was well known that by using active carbon can deodorize, and the active carbon includes coconut layer, sphere, fiber, and chemical treatment. Different processed have different particle size. Active carbon has high BET, so that it has large absorptive quantity. The pores with different shapes and sizes cover the active carbon surface, and it makes deodorant function. The major adsorptive targets are non-polar macromolecule and saturated molecule, such as benzene, toluene and methanethiol.

There are several ways to add active carbon to clothes, for example: (1) placing active carbon pellet between two-layers textile. However, the fabrics made from this way are heavier, thicker, non-portable, and uncomfortable. (2) Placing active carbon into cover into cover layer of yarn which will change physical properties. (3) Mixing active carbon and adhesive to adhere active carbon on fabric. Because of carbon covered by adhesive, textile has less deodorant ability and intolerance of washing. (4) Using active carbon fiber as a major material, accompanied with chemical synthetic fiber as a sub-material to produce fabric. However, this way has low weight ratio of active carbon so it has limited effect of deodorant. (5) Using carbon-fiber fabric, made from polyacrylonitrile (PAN), as adsorbent material. By using laminated process in textile with two or three layers, it has excellent adsorbent effect. It is suitable for military protected clothes, but high price, touching and weight are inappropriate for general application.

In view of these known drawbacks, and providing more comfortable and healthy clothes for human, it still requires to developed more comfortable textile with better deodorant ability.

### BRIEF DESCRIPTION OF THE DRAWINGS

FIG. 1. Observation of fabric containing coffee grounds powder by SEM at (a) 2000×; (b) 5000×. In the Figure, 10 means resin containing coffee grounds and 20 means coffee grounds powder.

FIG. 2 shows the difference of adsorptive ability between different fabrics. In the Figure, resin represents fabric coated with resin; coffee grounds represents fabric coated with resin, containing 5% coffee grounds powder; and zeolite represents fabric coated with resin, containing 5% zeolite powder.

### SUMMARY OF THE INVENTION

The present invention is related to a method of preparing a textile with a porous material, comprising: (a) mixing a solution containing the porous material, a resin and a foam stabilizer to form a mixture; (b) foaming the mixture of (a) to form a foam; (c) coating the foam of (b) to the surface of the textile; and (d) drying the textile of (c).

The present invention is also related to a textile with a porous material, comprising the porous material, a resin layer and a fabric, membrane or released substance.

### DETAILED DESCRIPTION OF THE INVENTION

This invention is related to a method of preparing a textile with a porous material, comprising: (a) mixing a solution containing the porous material, a resin and a foam stabilizer to form a mixture; (b) foaming the mixture of (a) to form a foam; (c) coating the foam of (b) to the surface of the textile; and (d) drying the textile of (c). Furthermore, the resin is selected from polyurethane(PU), polyacrylate, poly(ethylene terephthalate)(PET) or polycarbonate(PC).

In this invention, the porous material includes but is not limited to zeolite, coffee grounds, silicone, active carbon, meso-porous material, active carbon-fiber, nano-porous polymer material, and so on. Preferably, the porous materials are zeolite and coffee grounds. The coffee grounds are obtained from baking or carbonization, and are mixed in the solution. The porous material solution can further comprise microcapsule liquid, coffee extracted liquid, hot-melt liquid, or any liquid which can be added in the solution. Preferably, the solution is water. The mixture of porous material solution, resin and foam stabilizer can further comprises auxiliaries such as a foaming agent (e.g. stearic acid), a foam stabilizer, a cross-linking agent (e.g. isocyanate), or a catalyst. Preferably, the polyurethane is 1-100% by weight of the mixture. The mixture of porous material solution, resin and foam stabilizer further comprises 0.05-10% foaming agent, 0.05-10% cross-link agent, 0.05-10% catalyst, 0.05-10% foam stabilizer and 1-10% additives by weight of the mixture.

The auxiliaries in this invention have different functions. The foaming agent has foaming effect at high temperature (100° C.) or foaming by machinery shear strength. The cross-linking agent, which causes crosslinking reaction at high temperature, can provide resin the good physical properties, such as enhancing mechanical strength and hydrolysis. The foam stabilizer, amine compound from stearic acid, is used for maintaining foam stability after foaming from hydrophilic resin. The catalyst, an activator, adjusts reaction rates between isocyanate and hydroxyl group, isocyanate and water, and isocyanate itself to keep the three reactions normal and maintaining balance. The additive is selected from silica powder, silicon agent, porous material powder, thickner, water repellent agent, filler and/or surface modifier agent. Preferably, the surface modifier agent is selected from wax material, calcium carbonate or color pigment.

The mixture of this invention could be foamed by mechanical or chemical method after mixing. The mechanical method is generating foam with polyurethane, polyacrylate, poly(ethylene terepgthalate), or polycarbonate, by pumping into the air and through shear strength to have foaming ability. The chemical method means foaming itself at high temperature by using foaming agent which have foamable material under heating. The foaming ratio is 0.1-50 times of these two methods. The surface of fabric could be coated with foam in an amount of 0.5-500 g/m². The ratio of foaming and coating amount should be adjusted for various needs. The coating target could be hydrophilic or hydrophobic textile, such as woven fabric, knitting fabric, non-woven fabric membrane and released substance.

The coating method of this invention is coating the coffee grounds or zeolite powder on textile. The preparation procedures include coating, baking, drying and corsslinking. When the textile pass through the coating device, with roller and knife equipment, the foam could be coated on textile by the device. The oven condition for dehydration and crosslinking sets at 50-150° C. for 10-240 seconds. The thickness of the textile after coating increases about 0.01-5 mm. Finally, a porous surface is formed.

This invention further provides a textile with a porous material, comprising: (a) a fabric, membrane or released substance coated with a porous and resin layer; (b) at lease one porous material which is spread and exposed in the resin layer, covering the surface of the fabric, membrane or released substance; and (c) a resin layer covering the surface of the fabric, membrane or released substance. The porous material could be zeolite, coffee grounds, silicone, active carbon, meso-porous material, active carbon-fiber, nano-porous polymer material and so on. Preferably, the porous materials are zeolite and coffee grounds. The coffee grounds are obtained from baking or carbonization, and are mixed in the solution. The resin layer can further comprise microcapsule, hot-melt component, coffee grounds or coffee extracted essence. Preferably, the resin is an aqueous resin. More preferably, the resin is selected from polyurethane(PU), polyacrylate, poly(ethylene terephthalate)(PET) and/or polycarbonate(PC). More preferably, the resin is polyurethane. The coating target could be hydrophilic or hydrophobic textile, membrane or released substance. The fabric could be woven fabric, knitting fabric or non-woven fabric.

The size of powder used in the present invention is between 100 nm to 500 um.

The coating method of the present invention is used in final process to have broader application and simple process. Furthermore, the textile of the present invention has functions of deodorization(odor control), air permeability, simple process, low cost, and satisfaction for customers.

### EXAMPLES

The examples below are non-limiting and are merely representative of various aspects and features of the present invention.

### Example 1

### Preparation Procedure

Zeolite and coffee grounds were mixed into water to form a solution A. Various auxiliaries were added to polyurethane resin. The auxiliaries included a foaming agent, a cross-linking agent, a catalyst, a foam stabilizer and other additives, such as thickener, filler and so on. Polyurethane resin compound was mixed evenly with the auxiliaries to form a solution B. 5% w/w solution A and 95% w/w solution B were mixed by mechanical method to generate a foam. The foam was coated on the surface of fabric.

The composition of solution B was 2.5% other additives, 90% polyurethane resin compound, 2% foaming agent, 2% cross-linking agent, 0.5% catalyst, and 3% foam stabilizer. Polyurethane was pumped into air under mechanical power to form a foam. The foam was coated on the fabric to generate a porous surface.

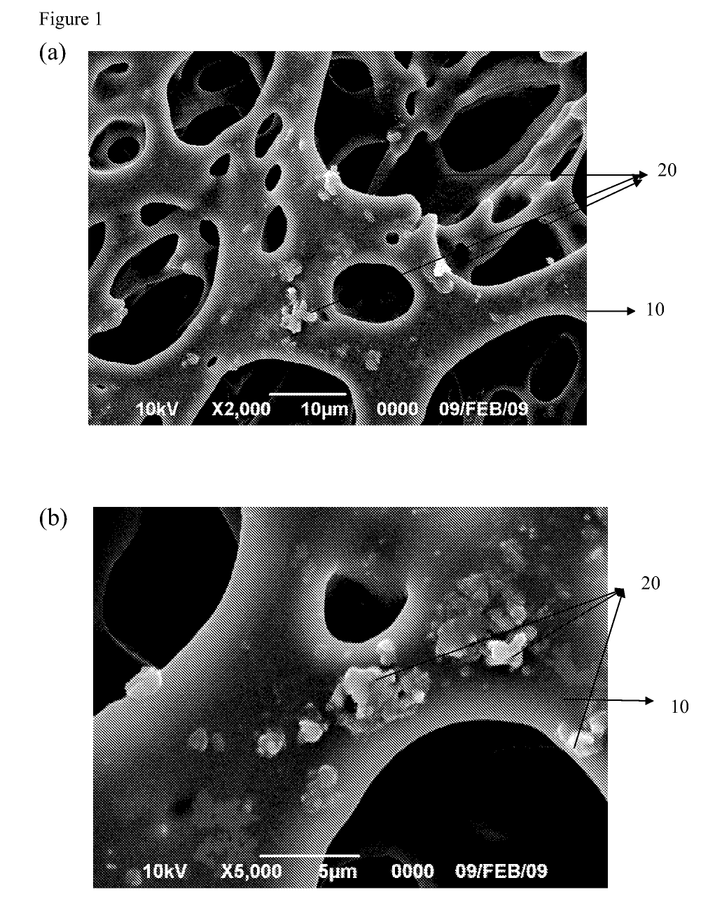

The preparation procedures included coating, baking, corsslinking, and so on. The coating devices contained roller and knife coating equipment, coated the foam prepared from the mixture of solution A and B on fabric. The fabric coated with the foam was passed through the oven, and dehydrated at 90° C. for 60 seconds and 150° C. for 60 seconds. Crosslinking reaction was also proceeded at the same time. The thickness of fabric increased 0.2 mm after rolling and coating. The final product was shown in FIG. 1.

### Example 2

### Adsorptive Ability Test

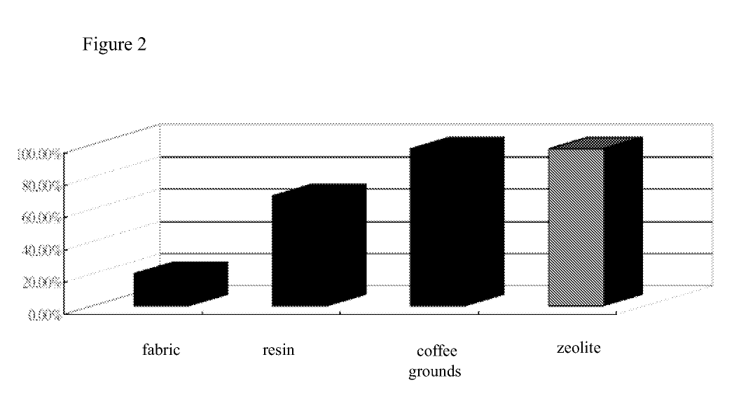

As shown in Table 1 and FIG. 2, fabric 1, the fiber without resin and porous material, was defined as “control group”. Fabric 2, the fiber coated with resin containing 5% coffee ground and Fabric 3, the fiber coated with resin is content 5% zeolite powder, were defined as “test group.” The adsorptive effect between sample and ammonia was determined by adsorptive test. The adsorptive test also represented the effect and ability of deodorization. The test method was referred to JAFET.

TABLE 1

| | Sample | Deodorization Rate (%) |
|---|---|---|
| Control gruop | Fabric 1 | 20.00 |
| Test group | Fabric 2 | 97.37 |
| | Fabric 3 | 97.37 |

As shown in Table 1, after adding coffee grounds and zeolite powder, the adsorptive ability of the fabric was higher than that only coated with foam alone. The adsorptive difference was clearly observed in FIG. 2.

Furthermore, the textile of the present invention was sent to Taiwan Textile Research Institute (TTRI) to run the JAFET deodorant ability test. The sample size was 10×10 cm².

Ammonia removing rate(%)=(residual concentration of test group/residual concentration of control group)×100.

The result of control fabric with coffee grounds was shown in Tables 2-3:

TABLE 2
Test No.: TFF8F301

| | | | The fabric with |
|---|---|---|---|
| | | | coffee ground |
| | | Control group | (test group) |
| 0 hour | Initial concentration | 100 | 100 |
| 1 hour | Residual concentration | 100 | 3 |
| | Deodorization rate (%) | — | 97 |

TABLE 3
Test No.: TC802037

| | | | The fabric with |
|---|---|---|---|
| | | Comparison | coffee grounds |
| | | group | (test group) |
| 0 hour | Initial concentration | 100 | 100 |
| 1 hour | Residual concentration | 100 | 13 |
| | Deodorization rate (%) | — | 87 |

### Example 3

### Air Permeability Test

In addition to adsorption test, air permeability value of different fabric was compared. The result was shown in Table 4. The value with coffee grounds or zeolite did not have significant difference. Therefore, adding the porous material would not influence the air permeability of fabric.

TABLE 4

| | | air permeability value |
|---|---|---|
| | Kind of sample | (cm3/cm2/sec, cfm) |
| Fabric | Fabric1 | 316 ± 5 |
| | Fabric2 | 15 ± 5 |
| | Fabric3 | 15 ± 5 |

One skilled in the art readily appreciates that the present invention is well adapted to carry out the objects and obtain the ends and advantages mentioned, as well as those inherent therein. The textile, and processes and methods for producing it are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations, which are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A method of preparing a textile with a porous material, comprising: (a) mixing the porous material solution, a resin and a foam stabilizer to form a mixture; (b) foaming the mixture of (a) to from a foam; (c) coating the foam of (b) to the surface of the textile; and (d) drying the textile of (c).

2. The method of claim 1, wherein the solution is water.

3. The method of claim 1, wherein the porous material solution further comprises microcapsule liquid, coffee extracted liquid, hot-melt liquid, or any liquid which can be added in the solution.

4. The method of claim 1, wherein the mixture of (a) further comprises a foaming agent, a foam stabilizer, a cross-linking agent, or a catalyst.

5. The method of claim 1, wherein the mixture of (a) further comprises 0.05-10% foaming agent, 0.05-10% cross-linking agent, 0.05-10% catalyst, 0.05-10% foam stabilizer and 1-10% additive by weight of the mixture.

6. The method of claim 5, wherein the additive is selected from silica powder, silicon agent, porous material powder, thickener, water repellent agent, filler or surface modifier agent.

7. The method of claim 6, wherein the surface modifier agent is selected from wax material, calcium carbonate or color pigment.

8. The method of claim 1, wherein the porous material is zeolite, coffee grounds, silicone, active carbon, meso-porous material, active carbon fiber, or nano-porous polymer.

9. The method of claim 1, wherein the resin is selected from polyurethane(PU), polyacrylate, poly(ethylene terepgthalate)(PET) and polycarbonate(PC).

10. The method of claim 9, wherein the polyurethane is 1-100% by weight of the mixture.

11. The method of claim 1, wherein the step of (b) is carried out by mechanic or chemical method.

12. The method of claim 1, wherein the quantity of coating foam of step (c) is 0.5-500 g/m².

13. The method of claim 1, wherein the foam has 0.1-50 foaming ratio.

14. The method of claim 1, wherein the textile is woven fabric, knitting fabric, non-woven fabric membrane or released substance.

15. A textile containing a porous material, comprising: (a) a fabric, membrane or released substance coated with a porous and resin layer; (b) at lease one porous material which is spread and exposed in the resin layer, covering the surface of the fabric, membrane or released substance; and (c) a resin layer covering the surface of the fabric, membrane or released substance.

16. The textile of claim 15, wherein the resin layer further comprises microcapsule, hot-melt component, coffee grounds or coffee extracted essence.

17. The textile of claim 15, wherein the resin is aqueous resin.

18. The textile of claim 17, wherein the resin is polyurethane(PU), polyacrylate, poly(ethylene terepgthalate)(PET) or polycarbonate(PC).

19. The textile of claim 15, wherein the fabric is woven fabric, knitting fabric or non-woven fabric.
